(19) United States
(12) Patent Application Publication
(10) Pub. No.: US 2007/0210268 A1
(43) Pub. Date: Sep. 13, 2007

(54) FLOW SPEED MEASURING APPARATUS AND FLOW SPEED MEASURING METHOD

(75) Inventors: Junta YAMAMICHI, Yokohama-shi (JP); Mie OKANO, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/684,283

(22) Filed: Mar. 9, 2007

(30) Foreign Application Priority Data
Mar. 13, 2006 (JP) 2006-067531

(51) Int. Cl. G01N 21/85; G01N 21/49

(52) U.S. Cl. 250/573

(57) ABSTRACT

Two different kinds of fluids are sent to a flow path for measurement in which a plurality of detection sections are provided, transit time of consecutive fluid, following preceding fluid, at each detection unit is detected, and a flow speed of the fluid is found from time required for the consecutive fluid to move between the plurality of detection sections. The present invention provides a measuring apparatus which measures the flow speed and a rate of flow in the flow path with suppressing an influence from the external to the fluid thereby, and a measuring method using the measuring apparatus.

### BACKGROUND OF THE INVENTION

1. Field of the Invention

The present invention relates to an apparatus and a method for measuring a flow speed of fluid in a flow path.

2. Description of the Related Art

As methods of measuring a flow speed and a rate of flow of fluid in a flow path, two methods are cited according to rough classification. A first method is a mechanical measuring method using a fluid sending unit, such as a pump or a syringe which is connected to the external. As such a method, there is an estimation method based on volume of an ejection unit of a solution sending apparatus, or a method of using a rotation speed of a fan provided in a flow path. A second method is an in-situ measuring method in a flow path. That is, it is a method of applying a substance, which is different from solution, such as light, heat or a bubble, from the external to measure thermally or optically a change generated in fluid. This method is disclosed in Japanese Patent Application Laid-Open No. 2002-148089, and Japanese Patent Application Laid-Open No. 2004-271523.

Nevertheless, in the conventional methods as mentioned above, in some cases, mechanical errors were caused or influenced from heat from the external and foreign materials affected a fluid component in a flow path. For example, when performing an analysis of a sample with combining measurement of a flow speed or a rate of flow of fluid, in some cases, measuring object materials, such as protein, were transformed or deteriorated by heat applied for measurement, or viscosity of the fluid was changed by temperature. In addition, when performing chemical synthesis in a flow path with combining measurements of a flow speed and a rate of flow of fluid, a side reaction which is not preferable may be generated.

### SUMMARY OF THE INVENTION

The present invention is made in view of such tasks in the above-mentioned background art, and aims at providing a measuring apparatus which measures a flow speed and a rate of flow in a flow path with suppressing an influence from the external to fluid, and a method using the measuring apparatus.

Further features of the present invention will become apparent from the following description of exemplary embodiments with reference to the attached drawings.

The present invention is directed to a flow speed measuring apparatus for measuring a flow speed of fluid which flows through an inside of a flow path continuously, including: a flow path for measurement in which two different kinds of fluids can be continuously sent; and a detecting section for detecting transit of a consecutive fluid following a preceding fluid between two different kinds of fluids, wherein a plurality of the detecting sections are provided in the flow path for measurement along a flow direction of the fluid.

The apparatus further can include a calculating unit of calculating a duration when the consecutive fluid passes through between the detecting sections from transit time of the consecutive fluid detected in the detecting section in an upstream section, and transit time of the consecutive fluid detected in a downstream section, and further calculating at least one of a flow speed and a rate of flow of the fluid on the basis of the duration.

The apparatus further can include an optical unit for detecting a refractive index change of the fluid.

The optical unit can include a unit of detecting the change of the refractive index by a plasmon resonance method.

The detecting section can have a plurality of metal structures, arranged with having a gap mutually, on a surface which contacts the fluid, and detects the refractive index change of the fluid, which contacts the surface, using the surface plasmon resonance method by the optical unit.

The detecting section can have a metal film on a surface which contacts the fluid, and detects the refractive index change of the fluid, which contacts the surface, using the surface plasmon resonance method by the optical unit.

The present invention is directed to a flow speed measuring method which measures a flow speed of liquid which flows in a flow path, which comprises the steps of: sending preceding fluid and consecutive fluid, which is different from the preceding fluid, continuously to a flow path for measurement which has a plurality of detecting sections arranged with a predetermined gap; detecting transit time of the consecutive fluid in each detecting section; and calculating elapsed time when the consecutive fluid arrives at the detecting section, located in downstream, from the detecting section, located in upstream, from transit time in the respective detecting sections, and further calculating a flow speed of the fluid on the basis of the elapsed time.

The detecting section can detect transit time of the consecutive fluid by detecting a refractive index change at the time of the consecutive fluid passing with following the preceding fluid. In the measuring method, an optical unit detects the refractive index change. The optical unit can detect the refractive index change using a plasmon resonance method.

Further features of the present invention will become apparent from the following description of exemplary embodiments with reference to the attached drawings.

### BRIEF DESCRIPTION OF THE DRAWINGS

FIG. 1 is a schematic diagram illustrating a measuring section in an embodiment of the present invention.

FIG. 2 is a schematic diagram illustrating a planar array of a detecting section in an embodiment of the present invention.

FIG. 3 is a schematic diagram illustrating a planar array of a detecting section in an embodiment of the present invention.

FIGS. 4A, 4B, 4C, 4D, 4E and 4F are diagrams of describing a production method of a detecting section in an embodiment of the present invention.

FIGS. 5A, 5B and 5C are diagrams of describing a production method of a detecting section in an embodiment of the present invention.

FIGS. 6A, 6B and 6C are diagrams of describing a production method of a detecting section in an embodiment of the present invention.

FIG. 7 is a diagram of describing a production method of a detecting section in an embodiment of the present invention.

FIG. 8 is a diagram of illustrating an example of construction of a measuring section in an embodiment of the present invention.

FIG. 9 is a diagram of illustrating an example of construction of a measuring section in an embodiment of the present invention.

FIG. 10 is a block diagram of a detecting device in an embodiment of the present invention.

FIGS. 11A, 11B and 11C illustrate an example of detection in a first example.

FIG. 12 illustrates an example of a SEM image of a metal structure of a detecting section of the first example.

FIG. 13 illustrates an example of a SEM image of a metal structure of a detecting section of a second example.

FIG. 14 illustrates an example of construction of a detecting section of a third example.

### DESCRIPTION OF THE EMBODIMENTS

The present invention provides the following embodiments.

That is, the present invention is an apparatus for measuring a flow speed of fluid which flows through an inside of a flow path continuously, and provides a flow speed measuring apparatus having a flow path for measurement in which two different kinds of fluids can be continuously sent, and a detecting section for detecting transit of consecutive fluid following a preceding fluid between the above-described two different kinds of fluids, characterized in that a plurality of above-mentioned detecting sections are provided in the above-mentioned flow path for measurement along a flow direction of the above-mentioned fluid. Such an apparatus may further have a calculating unit of calculating a duration when the consecutive fluid passes through between the detecting sections from transit time of the above-mentioned consecutive fluid detected in the detecting section in an upstream section, and transit time of the consecutive fluid detected in a downstream section, and further calculating at least one of a flow speed and a rate of flow of the fluid on the basis of the duration.

In addition, a concept of the “flow speed measuring apparatus” in the present invention and this specification is a concept of also including an apparatus which outputs a flow speed as information without outputting a rate of flow as information.

The flow speed measuring apparatus can have an optical unit for detecting a refractive index change of fluid which flows through a flow path. This is for the above-mentioned detecting section to detect a change of the refractive index at the time of the consecutive fluid passing with following the preceding fluid on the premise that liquids having refractive index difference between them are used as the above-mentioned preceding fluid and the above-mentioned consecutive fluid, and to detect the transit time of the consecutive fluid.

As the above-mentioned optical unit, a unit of detecting a change of the above-mentioned refractive index by a plasmon resonance method can be used.

When using the plasmon resonance method, the above-mentioned detecting section may have a plurality of metal structures, mutually arranged with a gap, on a surface which contacts the fluid, and detect a refractive index change of the fluid, which contacts this surface, using a surface plasmon resonance method by the above-mentioned optical unit. Alternatively, the above-mentioned detecting section may also have a metal thin film on a surface which contacts the fluid, and detect a refractive index change of the fluid, which contacts the surface, using the surface plasmon resonance method by the above-mentioned optical unit.

As the above-mentioned metal structure or the metal thin film, a film which includes any metal among gold, silver, copper, aluminum and platinum, or those alloys can be used suitably.

In addition, the present invention provides a flow speed measuring method which measures a flow speed of a liquid which flows in a flow path, characterized by including:

sending a preceding fluid and consecutive fluid, which is different from the preceding fluid, continuously to a flow path for measurement which has a plurality of detecting sections arranged with a predetermined gap;

detecting transit time of the above-mentioned consecutive fluid in each detecting section; and

calculating elapsed time when the above-mentioned consecutive fluid arrives at the detecting section, located in downstream, from the detecting section, located in upstream, from transit time in respective detecting sections, and further calculating a flow speed of the fluid on the basis of the elapsed time.

The flow speed measuring method may further include calculating a rate of flow in the above-mentioned flow path on the basis of the above-mentioned flow speed.

In addition, a concept of the “flow speed measuring method” in the present invention and this specification is a concept of also including a method which outputs a flow speed as information without outputting a rate of flow as information.

The transit time of the consecutive fluid can be detected by detecting a refractive index change by the above-mentioned detecting section at the time of the consecutive fluid passing with following the preceding fluid. This is a method of the above-mentioned detecting section detecting a change of the refractive index at the time of the consecutive fluid passing with following the preceding fluid using liquids having refractive index difference between them as the above-mentioned preceding fluid and the above-mentioned consecutive fluid, and detecting the transit time of the consecutive fluid.

The above-mentioned refractive index change is detectable by an optical unit.

The above-mentioned refractive index change can be detected using a plasmon resonance method as the above-mentioned optical unit.

When using the plasmon resonance method, using as the above-mentioned detecting section what has a plurality of metal structures, mutually arranged with a gap, on a surface which contacts the fluid, a refractive index change of the fluid, which contacts this surface, can be detected using the surface plasmon resonance method by the above-mentioned optical unit.

In addition, when using the plasmon resonance method, using as the above-mentioned detecting section what has a metal thin film on a surface which contacts the fluid, a refractive index change of the fluid, which contacts this surface, can be detected using the surface plasmon resonance method by the above-mentioned optical unit.

As the above-mentioned metal structure or the metal thin film, a film which includes any metal among gold, silver, copper, aluminum and platinum, or those alloys can be used suitably.

Hereafter, each aspect included in the present invention will be described in detail.

(Flow Speed and Rate of Flow Measuring Section)

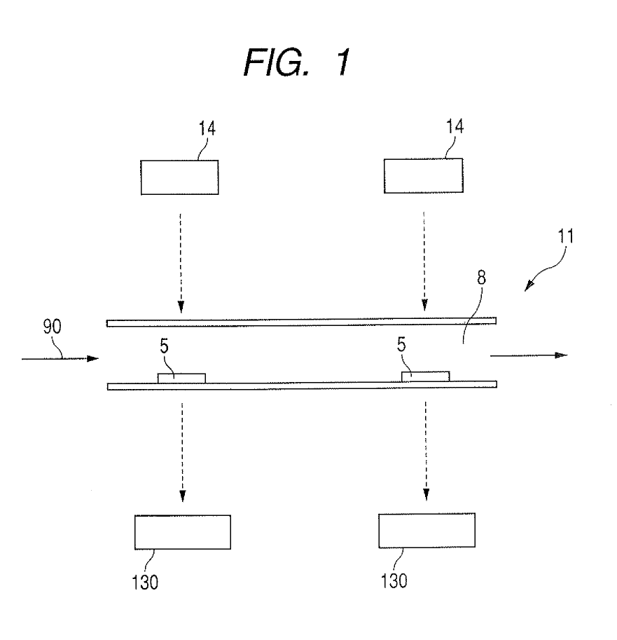

A flow speed measuring apparatus according to the present invention has at least a measuring section wherein a plurality of detecting sections for detecting transit of consecutive fluid following preceding fluid of two different fluids which flow continuously is arranged at predetermined intervals along a flow direction of the fluid in a flow path for measurement. FIG. 1 illustrates an example of the measuring section with structure of providing the detecting sections in two places in the upstream and downstream of the flow path. In this example, a sectional area of a flow path 8 for measurement which a measuring section 11 has is constant in full length, and is known (a predetermined value). In addition, two detecting sections 5 are arranged at a predetermined (known) interval. Hence, transit time of a fluid 90 in each detecting section is measured using a light source 14 and a detector 130, difference of the transit time, that is, elapsed time when the fluid arrives at the detecting section in the downstream from the detecting section in the upstream is found, and a flow speed of the fluid is computable from the found elapsed time. Furthermore, if needed, a rate of flow is computable on the basis of the flow speed found in this way. According to the present invention, the flow speed and rate of flow are measurable as actual measurements in the detecting sections in the flow path.

A flow speed and a rate of flow of liquid inside a flow path can be measured without or with less physical and chemical influences following flow speed measurement to a substance contained in a liquid by inserting and installing the measuring sections of this flow speed measuring apparatus in a flow path of various apparatuses, such as a reactor. The measuring sections of the flow speed measuring apparatus of the present invention can be installed in arbitrary positions in flow paths of various apparatuses, and, can measure a flow speed and a rate of flow in each location by being installed in more than one locations. In addition, a flow speed changes also with a change of a diameter of a flow path. Hence, it is also effective when controlling behavior of a substance in a flow path that a flow speed and a rate of flow are measurable as actual measurements in the measuring sections of the flow speed measuring apparatus of the present invention.

(Detecting Section)

The detecting section of the flow speed measuring apparatus related to the present invention detects the time when consecutive fluid passes through the detecting section. The detecting section should just have structure which can detect transit of the consecutive fluid. For example, when there is measurable difference of physical and/or chemical properties between preceding fluid and consecutive fluid, the detecting section can detect transit of the consecutive fluid by detecting these properties.

As the difference of properties between these two kinds of fluids, refractive indices reflecting difference between compositions or components of the fluids can be selected. When two kinds of fluids whose refractive indices are different according to composition etc. pass through the detecting section continuously, a refractive index change occurs. Then, by measuring this refractive index change, transit of the consecutive fluid can be detected. Since this refractive index change is measurable by an optical unit, a detection method without affecting or with hardly affecting a substance contained in the fluids can be provided.

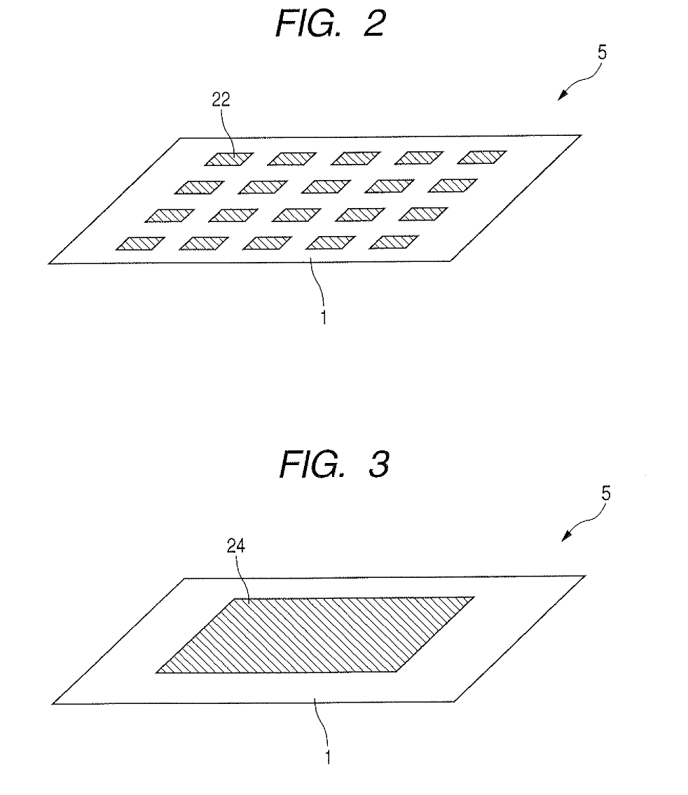

A surface plasmon resonance method can be cited as a suitable method of measuring the refractive index change in an optical unit. When giving the surface of the detecting section, contacting with the fluid, structure for obtaining surface plasmon resonance, the refractive index change in the fluid with different compositions can be measured in high sensitivity by the surface plasmon resonance using this surface structure. The surface structure of the detecting section which is used for measurement by such a surface plasmon resonance method is not limited particularly, but, structure of arranging a plurality of metal structures 22, which is represented by that in FIG. 2, on the surface of a substrate 1 with isolating them mutually, and structure of providing a metal thin films 24 on the surface of the substrate 1 as shown in FIG. 3 can be cited.

These metal structure and metal thin film relate to a so-called plasmon resonance phenomenon, and it is known that their optical characteristics change in response to a refractive index change near each of the metals. Refractive index sensors and biosensors using this phenomenon are put in practical use.

As materials used for forming the metal structure and metal thin film, any metal among gold, silver, copper, aluminum and platinum, or those alloys can be used. In view of adhesion with a substrate, the metal structure and metal thin film may be formed on an inner wall of a flow path through a thin film, such as a chromium or titanium thin film, between metal structure or metal thin film and the inner wall of the flow path. The metal structure and metal thin film are formed in a thickness of about 10 to 200 nm, for example. A planar shape of each metal structure and an arrangement form and an arrangement interval of respective metal structures are used with selecting suitably those which are necessary for detection. This is also the same in the metal thin film.

As a substrate for forming the metal structure or metal thin film, a glass substrate, a quartz substrate, a resin substrate, such as a polycarbonate or polystyrene substrate, an ITO substrate, or the like which is optically transparent can be used. That is, what is necessary is just a substrate which enables detection by the plasmon resonance method.

When it is expected that a component which exists in fluid is adsorbed by the above-mentioned metal structure or metal thin film nonspecifically, which affects a future analysis, reaction, etc. in consequence, it is desirable to give treatment for preventing nonspecific absorption on the above-mentioned metal structure or metal thin film. In that case, it is suitable to use polymer coating, self-organizing film coating, or protein coating such as bovine serum albumin or casein coating.

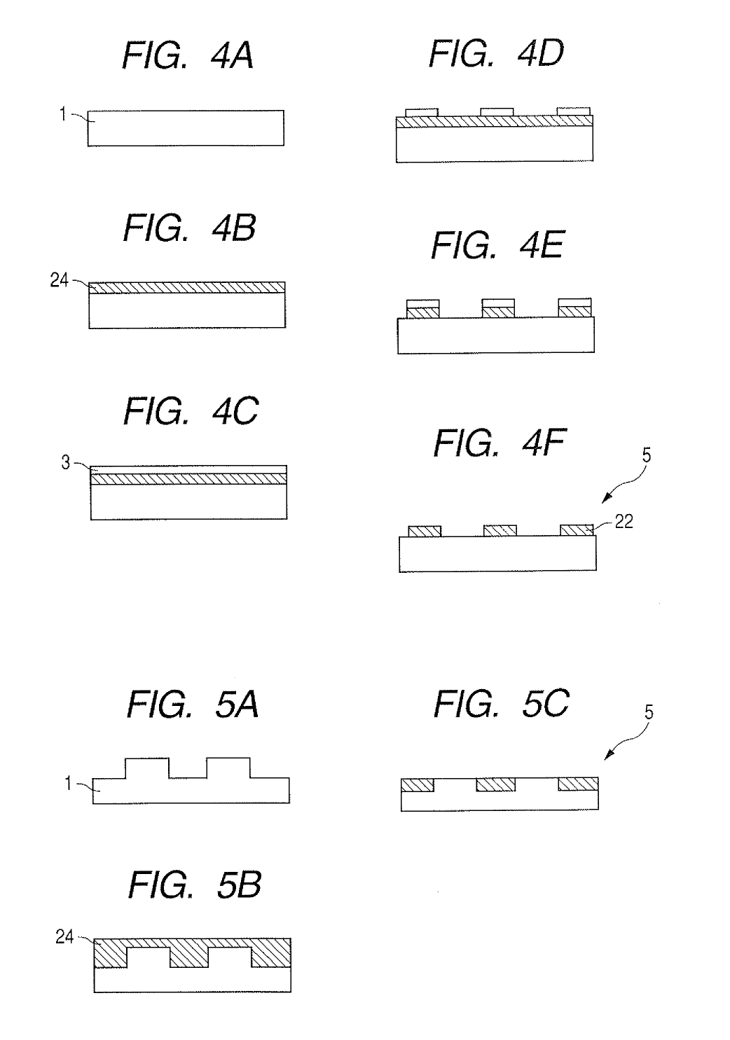

The detecting section can be obtained by forming a metal structure in a predetermined position of a substrate. FIGS. 4A to 4F illustrate an example of its production method. As illustrated in FIGS. 4A to 4F, in this example, a metal thin film 24 is first formed on the substrate 1 by a sputtering method or vacuum deposition (FIG. 4B). An electron beam resist 3 is formed by spin coating thereon (FIG. 4C), exposure is performed by an electron beam lithography system, and a resist pattern is obtained after development (FIG. 4D). Then, an unnecessary metal thin film is etched (FIG. 4E), and the resist is removed to form metal structures 22 arranged in an array (FIG. 4F). The metal structures 22 can be produced with patterning by a focused ion beam processing device, an X-ray aligner, and an EUV aligner besides the electron beam lithography system.

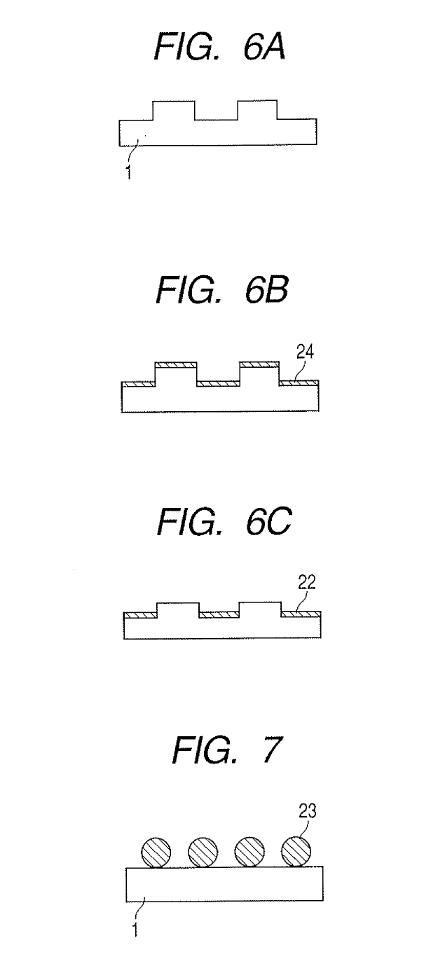

In addition, as illustrated in FIGS. 5A to 5C, a production method using the substrate 1 having fine convexoconcave structure on a surface (FIG. 5A) produced by a mold method is also possible. In this case, a metal thin film 24 is formed on the substrate 1 by the sputtering method or vacuum deposition (FIG. 5B). Next, by grinding the metal film on the surface to expose a convex substrate surface, the desired metal structures are formed on the substrate (FIG. 5C). Similarly, FIGS. 6A to 6C illustrate a production method at the case that the metal thin film 24 is thinner than unevenness of the substrate 1. A production method illustrated in this example is the same as that of the method illustrated in FIGS. 5A to 5C except that a thickness of the metal thin film to be sputtered is different. In this case, a convex section of the substrate 1 may be higher than a surface of the metal thin film 24, or the metal thin film 24 may be formed on a wall surface of the convexoconcave section. Here, the metal film can be removed using etchback by dry etching instead of grinding. Furthermore, as shown in FIG. 7, the removal can be also performed by a chemical immobilizing method of golden colloid fine grains 23 to the inside wall. Dispersed immobilization of metal microparticles can be performed by adding golden colloid after aminating the substrate surface by a silane coupling agent etc. beforehand.

(Flow Path)

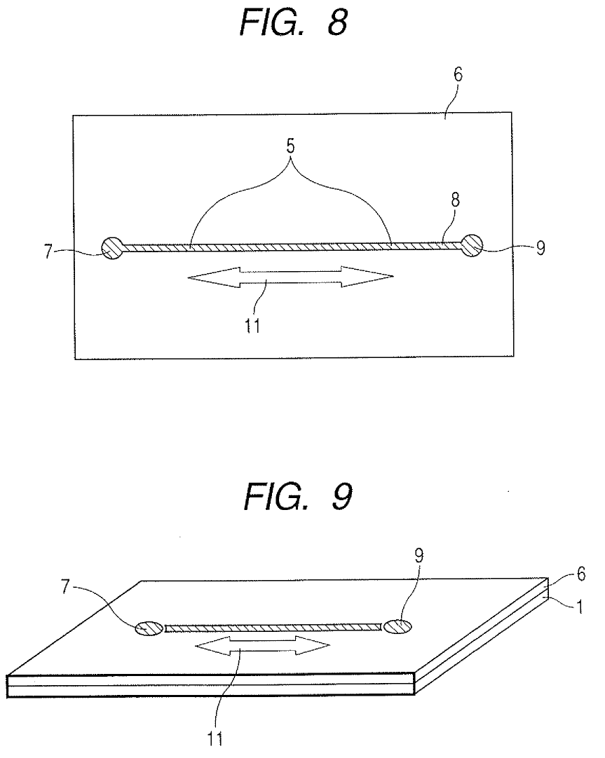

After the detecting section is produced on a base material as mentioned above, flow path structure is constructed by bonding a substrate separately made of a poly dimethyl siloxane (PDMS) resin, a polystyrene resin, a polycarbonate resin, or the like on the base material. As shown in FIG. 8, since, on the base material 6 made of resin, for example, a rectangular minute flow path 8 with 100 μm of width and 100 μm of depth is patterned, a flow speed measuring section 11 can be constructed by bonding the base material 6 with the substrate 1. In addition, FIG. 8 illustrates a carrying fluid inlet 7, an outlet 9, and detecting sections 5. FIG. 9 is a perspective view illustrating a state of bonding the substrate and base material. In this example, through holes are perforated at the positions corresponding to the above-mentioned inlet 7 and outlet 9 on the substrate side on which the metal structures 22 and/or the metal thin film 24 are formed. Thereby, this base material can be used with combining other flow paths through the through holes used as the inlet and outlet. In addition, a micro piston pump, a syringe pump, or the like can be used as a solution sending mechanism.

(Fluid)

A fluid is a liquid or a gas, for example. The liquid is an aqueous solution etc. In this embodiment, a substance which generates a refractive index change depending on content of the substance needs to be contained in fluid. For example, a high polymer such as protein is used suitably. Such a system is useful in combination with a biosensor which measures a proteinic amount. In such a case, it is because it is necessary in a biosensor using a flow path to control a flow speed and a rate of flow for control of a signal amount, so as to make an optimum measuring condition.

(Measuring Apparatus and Measuring Method)

As mentioned above, the measuring section of the flow speed measuring apparatus of the present invention is constructed with having a flow path, and at least a plurality of detecting sections arranged at a predetermined interval in a flow path. This apparatus can further have time detecting units of detecting transit time of fluid between two detecting sections, which is obtained in the measuring sections, and a calculating unit of calculating at least one of a flow speed and a rate of flow of the fluid on the basis of this detected time. That is, this apparatus detects elapsed time until consecutive fluid detected by the detecting section in an upstream section is detected by the detecting section in a downstream section, and calculates the flow speed of the fluid by the calculating unit which uses an arithmetic unit, such as a computer, on the basis of this elapsed time. Furthermore, this apparatus calculates the rate of flow from the flow speed obtained if needed. Furthermore, this apparatus can display or record the flow speed and rate of flow, which are obtained, by providing display unit such as a display monitor, and recording unit such as a printer.

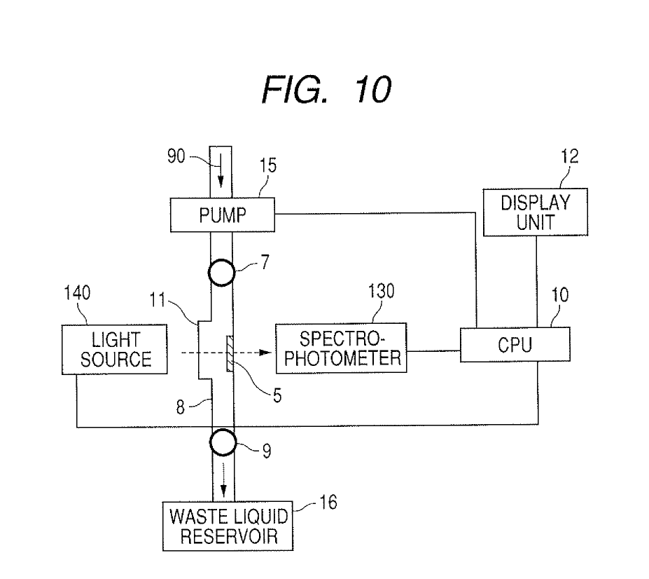

Next, measurement of a flow speed and a rate of flow in a flow path using the measuring apparatus with the above-mentioned structure will be described using FIG. 10. This measuring apparatus is constructed with having at least a holding unit which holds the measuring section 11 with the above-mentioned structure and is not illustrated, and a detection unit for detecting a signal from a detecting section 5.

What can be used suitably as a detection unit in the detecting section 5 is one which has an optical detection system which includes a light source unit 140, a spectrophotometer 130, and lenses not illustrated, a solution sending system which includes a flow path 8 and a inlet 7 for moving a fluid 90 to the detecting section 5, a solution-sending pump 15 as a solution-sending mechanism, and a outlet 9 and flow path 8 for exhausting waste liquid from the detecting section, and a waste liquid reservoir 16 for reserving the waste liquid. What can cover a wavelength region from a visible region to a near infrared region can be used for the light source. As the optical measurement, an absorption spectrum, a transmission spectrum, a scattered spectrum, and a reflection spectrum can be used. Most suitably, in the case of metal structure, a peak wavelength or peak absorption intensity of the absorption spectrum is used, and in the case of a metal thin film, the reflection spectrum or a reflected light intensity change is used. In regard to a metal structure or a metal thin film which the detecting section has, since a surface plasmon resonance state changes according to a refractive index of a nearby fluid, a peak wavelength and absorption intensity of the absorption spectrum, and reflective strength are shifted.

Next, an example of measurement of a flow speed or a rate of flow at the time when two kinds of liquids which have difference between the refractive indices on the basis of different compositions are poured continuously in the flow path of the measuring section in this apparatus will be described below.

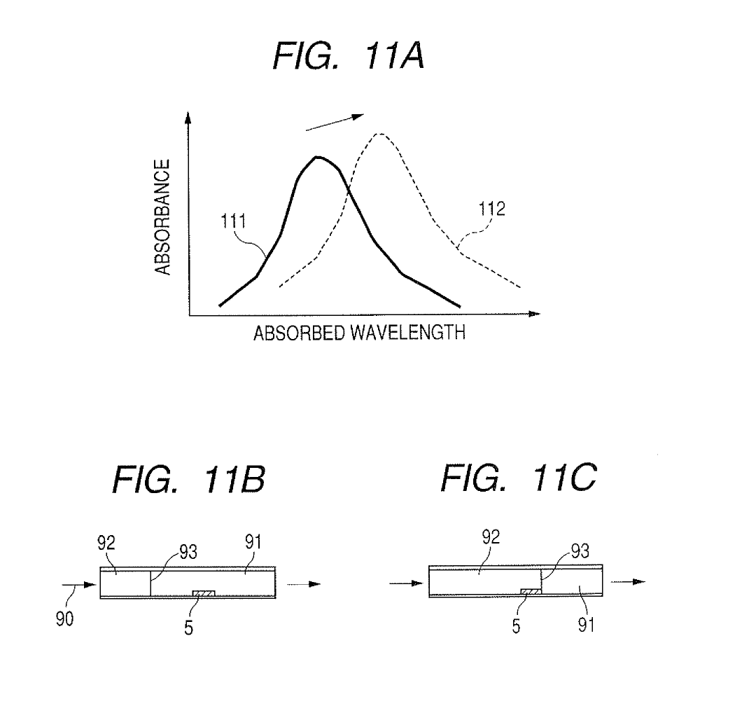

Since the two kinds of fluids which flow in the flow path are different in compositions, there is difference between their refractive indices. Time when a boundary section between first fluid which flows in the measuring section with preceding, and second fluid which flows consecutively in the flow path and has a different composition passes the measuring section is measured with timing of a shift of the above-mentioned spectrum or strength. Determination of the shift is performed with a threshold determined experimentally (refer to FIGS. 11A to 11C). In this measuring section, a plurality of above-mentioned detecting sections exist, and time (t1, t2 . . . ) when the boundary section of the first fluid and second fluid passes through each detecting section can be measured one by one. Here, speed v of the fluid is computable with the following formula (1).

v=l/(t1−t2) (1)

where
l: distance (known) between a detecting section which was passed at t1, and a detecting section which was passed at t2,
t1: transit time of fluid measured in the first detecting section, and
t2: transit time of fluid measured in the second detecting section.

A rate of flow is computable from the above-mentioned flow speed and a sectional area (known) of the flow path of the measuring section. Although a boundary section may be mixed a little depending on compositions of the first fluid and second fluid, mixing in such an infinitesimal area does not exert its influence on applications supposed in this flow speed measuring method.

A central processing unit 10 can calculate the above-mentioned flow speed and rate of flow. The calculation results can be output through a display unit 12, such as a CRT, a liquid crystal display, or a printer (not illustrated).

### EXAMPLES

The present invention will be further specifically explained with examples below. In addition, the present invention is not limited only to the following examples.

### Example 1

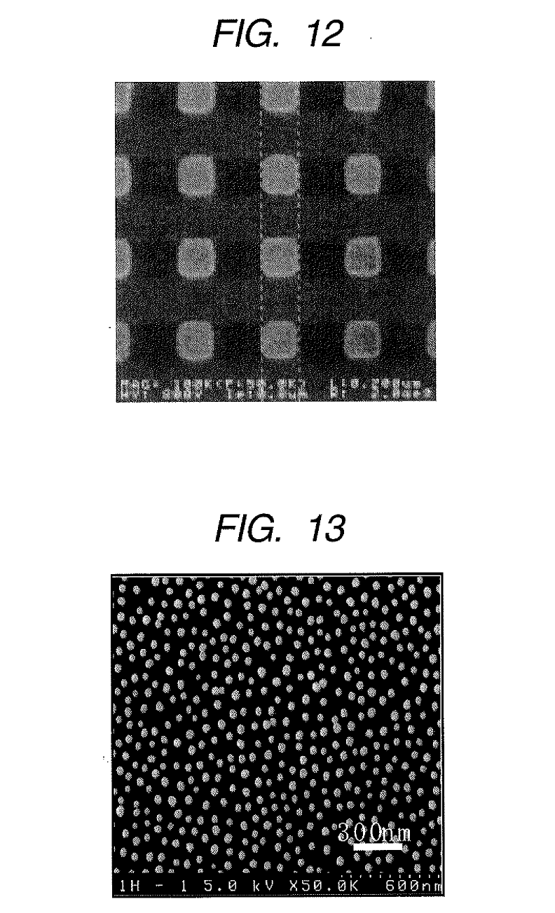

Schematic structure of a detecting apparatus used in this example is illustrated in FIG. 10. A detecting section was produced by forming a gold thin film with 20 nm of film thickness on a quartz substrate with 525 μm of thickness, and patterning this into a predetermined pattern using an electron-beam lithography system. As shown in a scanning electron microscope (SEM) image of FIG. 12, an external form of a planar shape of a metal structure is a square form of 200 nm×200 nm. Depending on a degree of resolution, the external shape cannot be necessarily produced at sharp angles. Each pattern is arranged in an array with 250 nm of space. Two of these patterns are arranged with keeping 1 cm of gap for two detecting sections for flow speed measurement to be prepared. The absorption spectrum of the structure of this example has a peak wavelength near 800 nm.

The flow path of this example is molded using a polystyrene resin. The flow path is made into a rectangular shape with 100 μm in width and 100 μm in depth. The flow path is bonded with a base material, where the above-described detecting sections are formed, using an UV cure adhesive. Through holes for an inlet and an outlet were beforehand perforated in the base material, and are used for connection with devices of a solution sending system.

As to measurement fluids of a flow speed, a phosphate buffer is used as a first fluid which precedently flows, and a phosphate buffer of 10 mg/ml of human alpha fetoprotein (AFP) is used as a second fluid which flows continuously and has different composition, which are sent by a syringe pump connected to the inlet.

The first fluid will be compared with the second fluid about absorption spectra. One example is illustrated in FIGS. 11A to 11C. The spectra before and after an interface 93 between fluids 91 and 92 illustrated in FIGS. 11B and 11C passes through the detecting section 5 are expressed by curves 111 and 112 in FIG. 11A, respectively. When the interface 93 between the two kinds of fluids 91 and 92 passes through the detecting section 5, the absorption spectrum shifts to 112 from 111. Time for the fluid to pass is measured from shift timing of peak intensity or a peak wavelength of the absorption spectrum. Measurements are sent to an arithmetic unit and the flow speed can be measured from formula (1).

### Example 2

In the detecting apparatus illustrated in the first example, air is used as a first fluid and water is used as a second fluid. A detecting section was produced by immobilizing golden colloid with a particle diameter of 40 nm on a 525-μm-thick quartz substrate. At the time of immobilization, when gold colloid solution (made by Tanaka Kikinzoku Kogyo) is immersed for 12 hours after quartz surface treatment with 3-amino propyl trimethoxysilane (made by Shin-Etsu Chemical Co., Ltd.), dispersed immobilization as shown in a scanning electron microscope (SEM) image of FIG. 13 is possible. Two of these patterns are arranged with keeping a 1 cm gap for two detecting sections for flow speed measurement to be arranged. The absorption spectrum of the metal structure of this example has a peak wavelength near 510 nm. The flow speed is measured by performing solution-sending similarly to the first example to detect a boundary section from air to water with a shift of a peak wavelength.

### Example 3

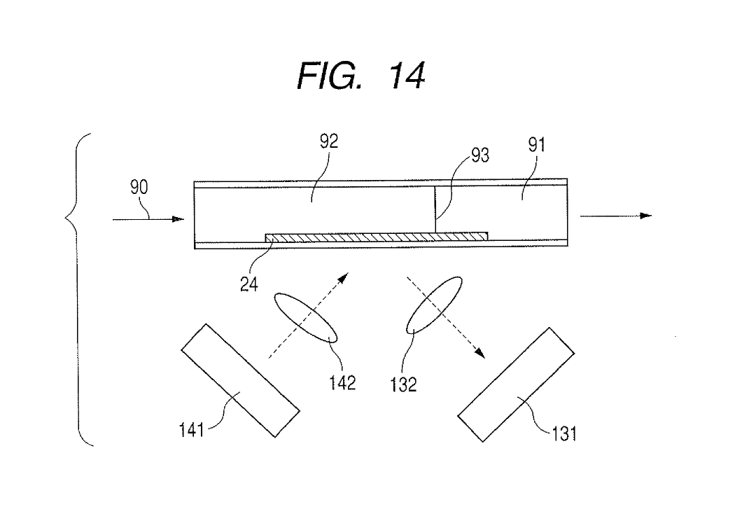

A detecting section is made of a gold thin film with 50 nm of film thickness. Dimensions of the gold thin film is 100 μm×100 μm, the same flow path is used as that of the above-mentioned example, and the gold thin film is made into such size that the gold thin film may fit in the flow path. Two of these metal films are arranged with keeping a 1 cm gap to be made into two detecting sections. As for measurement, light from a light source passes through an optical system, where a laser diode 141, collimator lenses 142 and 132, and a photomultiplier tube 131 are arranged, as illustrated in FIG. 14, and is reflected by the gold thin film. Transit of a boundary section between the fluids is detected using a peak shift of a reflection spectrum of the reflected light or an angle shift of peak intensity of the reflected light at a specified wavelength, and the flow speed is measured.

According to the suitable examples of the present invention, a measuring apparatus which measures a flow speed and a rate of flow in a flow path with suppressing an influence from the external to a fluid, and a method using the measuring apparatus can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent No. 2006-067531, filed Mar. 13, 2006, which is hereby incorporated by reference herein in its entirety.

What is claimed is:

1. A flow speed measuring apparatus for measuring a flow speed of fluid which flows through an inside of a flow path continuously, including:
a flow path for measurement in which two different kinds of fluids can be continuously sent; and
a detecting section for detecting transit of a consecutive fluid following a preceding fluid between two different kinds of fluids, wherein a plurality of the detecting sections are provided in the flow path for measurement along a flow direction of the fluid.

2. The apparatus according to claim 1, further including a calculating unit of calculating a duration when the consecutive fluid passes through between the detecting sections from transit time of the consecutive fluid detected in the detecting section in an upstream section, and transit time of the consecutive fluid detected in a downstream section, and further calculating at least one of a flow speed and a rate of flow of the fluid on the basis of the duration.

3. The apparatus according to claim 1, further including an optical unit for detecting a refractive index change of the fluid.

4. The apparatus according to claim 3, wherein the optical unit includes a unit of detecting the change of the refractive index by a plasmon resonance method.

5. The apparatus according to claim 4, wherein the detecting section has a plurality of metal structures, arranged with having a gap mutually, on a surface which contacts the fluid, and detects the refractive index change of the fluid, which contacts the surface, using the surface plasmon resonance method by the optical unit.

6. The apparatus according to claim 4, wherein the detecting section has a metal film on a surface which contacts the fluid, and detects the refractive index change of the fluid, which contacts the surface, using the surface plasmon resonance method by the optical unit.

7. A flow speed measuring method which measures a flow speed of liquid which flows in a flow path, which comprises the steps of:
sending preceding fluid and consecutive fluid, which is different from the preceding fluid, continuously to a flow path for measurement which has a plurality of detecting sections arranged with a predetermined gap;
detecting transit time of the consecutive fluid in each detecting section; and
calculating elapsed time when the consecutive fluid arrives at the detecting section, located in downstream, from the detecting section, located in upstream, from transit time in the respective detecting sections, and further calculating a flow speed of the fluid on the basis of the elapsed time.

8. The measuring method according to claim 7, wherein the detecting section detects transit time of the consecutive fluid by detecting a refractive index change at the time of the consecutive fluid passing with following the preceding fluid.

9. The measuring method according to claim 8, wherein an optical unit detects the refractive index change.

10. The measuring method according to claim 9, wherein the optical unit detects the refractive index change using a plasmon resonance method.
